(19) United States
(12) Patent Application Publication
(10) Pub. No.: US 2026/0319289 A1
(43) Pub. Date: Oct. 15, 2026

(54) LIQUID CRYSTAL DISPLAY PANEL AND METHOD FOR MANUFACTURING THEREOF, AND LIQUID CRYSTAL DISPLAY DEVICE

(71) Applicant: BOE Technology Group Co., Ltd., Beijing (CN)

(72) Inventors: Jiahui HAN, Beijing (CN); Shunhang ZHANG, Beijing (CN); Tianmin ZHOU, Beijing (CN); Yutong YAN, Beijing (CN); Pengxia LIANG, Beijing (CN); Zheng FANG, Beijing (CN); Ruizhi YANG, Beijing (CN); Xue DONG, Beijing (CN); Hui GUO, Beijing (CN)

(21) Appl. No.: 19/485,035

(22) PCT Filed: Apr. 17, 2024
(86) PCT No.: PCT/CN2024/088338

§ 371 Date: Nov. 17, 2025

(30) Foreign Application Priority Data
May 22, 2023 (CN) 202310580343.9

(51) Int. Cl. G02F 1/1335; G02F 1/1343; G02F 1/1362

(52) U.S. Cl. CPC G02F 1/133526; G02F 1/133512; G02F 1/133514; G02F 1/134318; G02F 1/13439; G02F 1/136227; G02F 1/136286

(57) ABSTRACT

Provided is a liquid crystal display panel. The liquid crystal display panel includes: an array substrate, a color film substrate, and a liquid crystal layer, wherein the array substrate and the color film substrate are connected opposite to each other, and the liquid crystal layer is disposed between the array substrate and the color film substrate; the color film substrate includes a color film layer and a black matrix; and the array substrate includes a common electrode layer.

### CROSS-REFERENCE TO RELATED APPLICATION

The present disclosure is a U.S. national stage of international application No. PCT/CN2024/088338, filed on Apr. 17, 2024, which claims priority to Chinese Patent Application No. 202310580343.9, filed on May 22, 2023, and entitled “LIQUID CRYSTAL DISPLAY PANEL AND LIQUID CRYSTAL DISPLAY DEVICE”, the disclosure of which is herein incorporated by reference in its entirety.

### TECHNICAL FIELD

Embodiments of the present disclosure relate to the field of display technologies, and in particular, relate to a liquid crystal display panel and a method for manufacturing thereof, and a liquid crystal display device.

### BACKGROUND

A liquid crystal display panel is a common display panel, which has the advantages of low manufacturing cost and simple manufacturing process and occupies a large market share in the field of display technologies.

### SUMMARY

Embodiments of the present disclosure provide a liquid crystal display panel and a method for manufacturing thereof, and a liquid crystal display device. The technical solutions are as follows.

In some embodiments of the present disclosure, a liquid crystal display panel is provided. The liquid crystal display panel includes an array substrate, a color film substrate, and a liquid crystal layer, wherein the array substrate and the color film substrate are connected opposite to each other, and the liquid crystal layer is disposed between the array substrate and the color film substrate; the color film substrate includes a color film layer and a black matrix, wherein the color film layer includes a plurality of arrayed color resistance blocks, the black matrix is disposed on the side of the color film layer proximal to the array substrate, and the black matrix includes a plurality of light-shielding parts, wherein orthographic projections of the plurality of light-shielding parts on the color film layer are located at junctions of the plurality of color resistance blocks; and the array substrate includes a common electrode layer, wherein the common electrode layer is provided with a plurality of arrayed slits and includes a plurality of electrode parts, wherein the plurality of electrode parts include a first electrode part disposed between a first slit and a second slit, an orthographic projection of the first electrode part on the color film layer is at least partially overlapped with an orthographic projection of a first light-shielding part on the color film layer, and the first slit and the second slit are two adjacent slits of the plurality of slits.

In some embodiments, a ratio of a sum of a width of the first light-shielding part and a width of the first electrode part to twice a target distance is equal to a tangent value of a target angle, wherein the target angle is determined based on a maximum viewing angle of the liquid crystal display panel; the target distance is a distance between the first light-shielding part and the first electrode part; the target angle is an angle between a connection line between projections of a first side edge of the first electrode part and a second side edge of the first light-shielding part in a reference plane and a thickness direction of the liquid crystal display panel, wherein the reference plane is perpendicular to the first side edge and the second side edge; and in an arrangement direction of the first slit and the second slit, the first side edge is a side edge proximal to the first slit, and the second side edge is a side edge proximal to the second slit.

In some embodiments, the common electrode layer is made of a metal material.

In some embodiments, the array substrate further includes a base substrate, a drive circuit layer, a planarization layer, a connection electrode layer, a pixel electrode layer, and an insulating layer, wherein the base substrate, the drive circuit layer, the planarization layer, the pixel electrode layer, the insulating layer, and the common electrode layer are sequentially stacked; the planarization layer includes a body part provided with a plurality of through holes and a plurality of filling structures in the plurality of through holes, and the pixel electrode layer includes a plurality of arrayed pixel electrodes; the connection electrode layer includes a plurality of connection electrodes, a portion of a first connection electrode in the plurality of connection electrodes is disposed in a first through hole in the plurality of through holes and is electrically connected to the drive circuit layer, and another portion of the first connection electrode is disposed on a side of the planarization layer distal from the base substrate and is connected to a first pixel electrode in the plurality of pixel electrodes, and the first pixel electrode covers the first connection electrode and the plurality of filling structures in the first through hole.

In some embodiments, orthographic projections of the plurality of filling structures on a carrying face of the base substrate are at least partially do not overlapped with an orthographic projection of the black matrix on the carrying face of the base substrate.

In some embodiments, an orthographic projection of the first slit on the carrying face of the base substrate is within an orthographic projection of the first pixel electrode on the carrying face of the base substrate; or an orthographic projection of the first slit on the carrying face of the base substrate is at least partially overlapped with orthographic projections of a plurality of consecutive pixel electrodes arranged in a first direction on the carrying face of the base substrate, wherein the first direction is a length direction of the first slit.

In some embodiments, the connection electrode layer and the pixel electrode layer are both made of a transparent conductive material.

In some embodiments, the array substrate includes a dimming assembly, wherein the dimming assembly is disposed between the base substrate and the drive circuit layer; the drive circuit layer includes a plurality of wires, wherein an orthographic projection of each of the plurality of wires on the carrying face of the base substrate is at least partially overlapped with an orthographic projection of one of the plurality of electrode parts on the carrying face of the base substrate; the dimming assembly is configured to deflect, to the color film layer, light rays that are in light rays incident to the liquid crystal display panel from a side of the array substrate and that irradiate the plurality of wires, the plurality of electrode parts, or the black matrix.

In some embodiments, the dimming assembly includes a plurality of lenses, wherein the plurality of lenses are in one-to-one correspondence with the plurality of color resistance blocks, and orthographic projections of corresponding lenses and color resistance blocks on the carrying face of the base substrate are at least partially overlapped with each other.

In some embodiments, each of the plurality of lenses includes a top face and a bottom face, wherein the top face is an arc face protruding in a direction away from the base substrate, and the bottom face is connected to the carrying face of the base substrate.

In some embodiments, a focal length of each of the plurality of lenses is less than h*(b+c)/b and greater than (H+h)*(e+d)/(2e+d), wherein b represents a width of each of the plurality of wires in an arrangement direction of the first slit and the second slit, c represents a distance between two adjacent wires of the plurality of wires in the arrangement direction, d represents a width of each of the plurality of light-shielding parts in the arrangement direction, e represents a width of an opening region in the arrangement direction, H represents a distance between the side of a target wire proximal to the base substrate and the side of a target light-shielding part distal from the base substrate, and h represents a distance between the side of the target wire proximal to the base substrate and the bottom face of the lens; wherein the target lens is any one of the plurality of lenses, the target wire is a wire that is most proximal to the target lens in the plurality of wires in the drive circuit layer, and the target light-shielding part is a light-shielding part that is most proximal to the target lens in the plurality of light-shielding parts.

In some embodiments, a distance between the drive circuit layer and the bottom face of the lens satisfies that a deflection angle is greater than or equal to a first angle and less than or equal to a second angle, wherein the deflection angle is an angle between an emergent direction of an incident light ray upon passing through one of the plurality of lenses and a direction perpendicular to the carrying face of the base substrate, the first angle is an angle between a connection line between the edge of a bottom face of the target lens and the edge of the side of the target wire proximal to the base substrate, and a direction perpendicular to the carrying face of the base substrate, and the second angle is an angle between a connection line between the edge of the bottom face of the target lens and the edge of the side of the target light-shielding part distal from the base substrate, and the direction perpendicular to the carrying face of the base substrate.

In some embodiments, the first angle satisfies that tanθ1=b/(2h); and the second angle satisfies that tanθ2=(2e+d)/(2H+2h), wherein θ1 represents the first angle, and θ2 represents the second angle.

In some embodiments of the present disclosure, a liquid crystal display device is provided. The liquid crystal display device includes a backlight assembly and any one of the liquid crystal display panels as described above, and the backlight assembly is configured to provide a light source for the liquid crystal display panel.

In some embodiments of the present disclosure, a method for manufacturing a liquid crystal display panel is provided. The method includes: providing an array substrate and a color film substrate, wherein the color film substrate includes a color film layer and a black matrix, wherein the color film layer includes a plurality of arrayed color resistance blocks, the black matrix is disposed on the side of the color film layer proximal to the array substrate, and the black matrix includes a plurality of light-shielding parts, wherein orthographic projections of the plurality of light-shielding parts on the color film layer are located at junctions of the plurality of color resistance blocks; and the array substrate includes a common electrode layer, the common electrode layer includes a plurality of arrayed slits and includes a plurality of electrode parts, wherein the plurality of electrode parts include a first electrode part disposed between a first slit and a second slit, and the first slit and the second slit are two adjacent slits of the plurality of slits; oppositely connecting the array substrate and the color film substrate, such that an orthographic projection of the first electrode part on the color film layer is at least partially overlapped with an orthographic projection of a first light-shielding part on the color film layer, and a width of the first electrode part is greater than a width of the first light-shielding part in the plurality of light-shielding parts in an arrangement direction of the first slit and the second slit; and acquiring a liquid crystal display panel by forming a liquid crystal layer between the array substrate and the color film substrate.

### BRIEF DESCRIPTION OF DRAWINGS

For clearer illustration of technical solutions according to the embodiments of the present disclosure, the accompanying drawings required for describing the embodiments are briefly introduced hereinafter. It is apparent that the accompanying drawings in the description hereinafter are only for some embodiments of the present disclosure, and those of ordinary skill in the art may derive other accompanying drawings based on the accompanying drawings without creative efforts.

FIG. 1 is a schematic diagram of a cross-sectional structure of a liquid crystal display panel according to some embodiments of the present disclosure;

FIG. 2 is a schematic top view illustrating a relationship between a black matrix and a color film layer according to some embodiments of the present disclosure;

FIG. 3 is a schematic top view illustrating a relationship between a common electrode layer and a black matrix according to some embodiments of the present disclosure;

FIG. 4 is a schematic diagram illustrating a relationship between a target angle, a target distance, a first light-shielding part, and a first electrode part according to some embodiments of the present disclosure;

FIG. 5 is a schematic diagram of a cross-sectional structure of another liquid crystal display panel according to some embodiments of the present disclosure;

FIG. 6 is a schematic diagram of a planar structure of a liquid crystal display panel in some practices;

FIG. 7 is a schematic diagram of a planar structure of a liquid crystal display panel according to some embodiments of the present disclosure, and FIG. 5 is a schematic diagram of a cross-sectional structure taken along a line AA in FIG. 7;

FIG. 8 is a schematic diagram of a cross-sectional structure of another liquid crystal display panel according to some embodiments of the present disclosure;

FIG. 9 is a schematic structural diagram of a lens according to some embodiments of the present disclosure;

FIG. 10 is a schematic diagram of a light path of a liquid crystal display panel including a lens according to some embodiments of the present disclosure;

FIG. 11 is a schematic diagram of a light path of another liquid crystal display panel including a lens according to some embodiments of the present disclosure; and

FIG. 12 is a flowchart of a method for manufacturing a liquid crystal display panel according to some embodiments of the present disclosure.

### REFERENCE NUMERALS

1: array substrate 2: color film substrate 3: liquid crystal layer
20: transparent substrate 21: color film layer 210: color resistance block
22: black matrix 220: light-shielding part 2201: first light-shielding part
23: cover layer
11: common electrode layer 110: electrode part 1101: first electrode part
111: slit 1111: first slit 1112: second slit
x: first direction y: second direction
D: width of first electrode part d: width of first light-shielding part
12: base substrate 13: drive circuit layer 130: wire (data line)
131: gate line 132: via hole 133: active region
14: planarization layer 15: connection electrode layer 16: pixel electrode layer 17: insulating layer
141: body part 142: filling structure 143: first through hole in planarization layer
151: first connection electrode 161: pixel electrode 1611: first pixel electrode
18: dimming assembly 180: lens 181: top face 182: bottom face
41: connection line between edge of bottom face of target lens and edge of side of target wire proximal to base substrate
42: connection line between edge of bottom face of target lens and edge of side of target light-shielding part proximal to base substrate

### DETAILED DESCRIPTION

For clearer descriptions of the objectives, technical solutions, and advantages of the present disclosure, embodiments of the present disclosure are further described in detail hereinafter with reference to the accompanying drawings.

Terms used in the embodiments of the present disclosure are defined to merely explain the embodiments of the present disclosure and are not intended to limit the present disclosure. Unless otherwise defined, technical or scientific terms used in the embodiments of the present disclosure should have the ordinary meanings as understood by those of ordinary skill in the art to which the present disclosure belongs. The terms “first,” “second,” “third,” and other similar words, as used in the description and the appended claims of the patent application of the present disclosure, do not indicate any order, quantity, or importance, but are merely defined to distinguish different components. Likewise, the terms “a,” “an,” or other similar words do not indicate a limitation of quantity, but rather the presence of at least one. The terms “include,” “comprise,” or other similar words indicate that the elements or objects stated before “include” or “comprise” encompass the elements or objects and equivalents thereof listed after “include” or “comprise”, but do not exclude other elements or objects.

In some practices, the liquid crystal display panel includes an array substrate, a color film substrate, and a liquid crystal layer. The array substrate and the color film substrate are connected opposite to each other, and the liquid crystal layer is disposed between the array substrate and the color film substrate. The color film substrate includes a color film layer and a black matrix. The color film layer includes a plurality of arrayed color resistance blocks, and the black matrix is disposed between any two adjacent color resistance blocks.

However, the liquid crystal display panel has the black matrix with a large width and a low pixel aperture ratio.

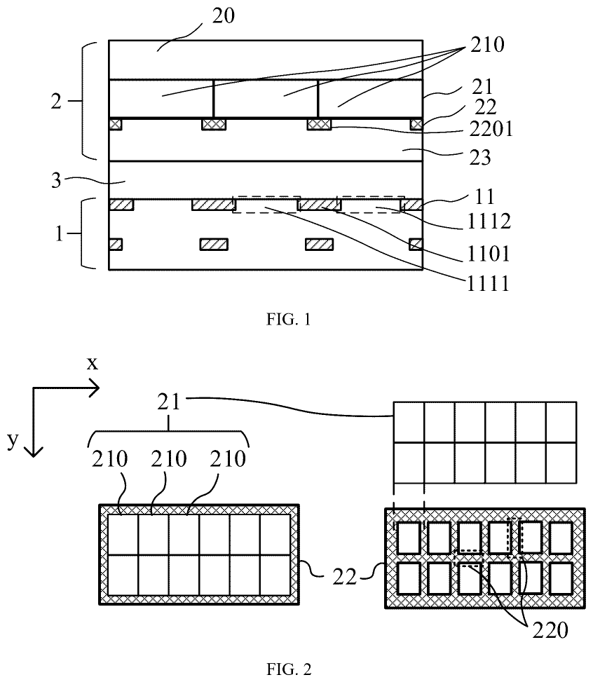

FIG. 1 is a schematic diagram of a cross-sectional structure of a liquid crystal display panel according to some embodiments of the present disclosure. As illustrated in FIG. 1, the liquid crystal display panel includes an array substrate 1, a color film substrate 2, and a liquid crystal layer 3. The array substrate 1 and the color film substrate 2 are connected opposite to each other, and the liquid crystal layer 3 is disposed between the array substrate 1 and the color film substrate 2.

FIG. 2 is a schematic top view illustrating a relationship between a black matrix and a color film layer according to some embodiments of the present disclosure. As illustrated in FIG. 1 and FIG. 2, the color film substrate 2 includes a transparent substrate 20, and a color film layer 21 and a black matrix 22 that are disposed on the transparent substrate 20.

The color film layer 21 includes a plurality of color resistance blocks 210. The plurality of color resistance blocks 210 are arrayed. The plurality of color resistance blocks 210 are organized into a plurality of color resistance block groups. Each of the color resistance block groups corresponds to one pixel unit of the liquid crystal display panel, and each of the color resistance block groups includes color resistance blocks of a plurality of colors. Each of the color resistance blocks allows light of a corresponding color to pass through. For example, in the embodiments illustrated in FIG. 2, each color resistance block group includes three color resistance blocks, that is, a red color resistance block, a blue color resistance block, and a green color resistance block.

The embodiments of the present disclosure do not limit the number, color, and arrangement of the color resistance blocks in each color resistance block group. In some other embodiments, one color resistance block group includes four color resistance blocks, and colors corresponding to the four color resistance blocks are red, blue, green and white, respectively, red, blue, green and yellow, respectively, or other combinations.

The black matrix 22 is disposed on the side of the color film layer 21 proximal to the array substrate 1, the black matrix 22 includes a plurality of light-shielding parts 220, and orthographic projections of the plurality of light-shielding parts 220 on the color film layer 21 are located at junctions of the plurality of color resistance blocks 210. This manner of disposing the black matrix 22 on the color film layer 21 is also referred to as a black matrix on color filter (BM On CF, where a black matrix is integrated on a color film or a color filter) structure.

In the embodiments illustrated in FIG. 2, a portion of the black matrix 22 disposed between two adjacent color resistance blocks 210 in a first direction x serves as a light-shielding part 220. Similarly, a portion of the black matrix 22 disposed between two adjacent color resistance blocks 210 in a second direction y also serves as a light-shielding part 220. The x direction is a row direction of the plurality of color resistance blocks 210, and the y direction is a column direction of the plurality of color resistance blocks 210. Alternatively, the x direction is a column direction of the plurality of color resistance blocks 210, and the y direction is a row direction of the plurality of color resistance blocks 210.

In some embodiments, as illustrated in FIG. 2, the color resistance blocks 210 are disposed adjoined to each other, that is, no gap exists between adjacent color resistance blocks 210, and the black matrix 22 is disposed at junctions of the color resistance blocks 210.

In some other embodiments, gaps exist among the plurality of color resistance blocks 210, and a portion of the black matrix 22 is disposed in the gaps.

Thicknesses of the color resistance blocks 210 are the same or different.

In some embodiments, the liquid crystal display panel further includes an over coat (OC, cover) layer 23. The OC layer 23 is disposed on the side of the black matrix 22 proximal to the array substrate 1. In some embodiments, the OC layer 23 is a resin layer configured to protect and planarize the black matrix 22 and the color film layer 21.

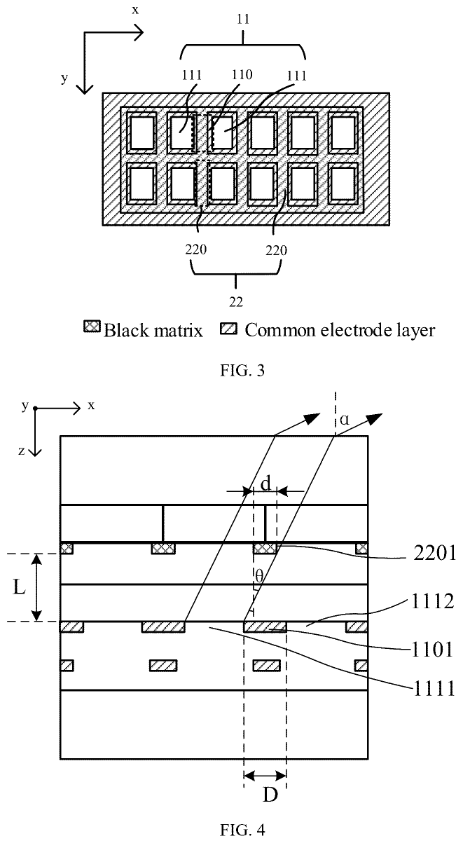

FIG. 3 is a schematic top view illustrating a relationship between a common electrode layer and a black matrix according to some embodiments of the present disclosure. With reference to FIG. 1 and FIG. 3, the array substrate 1 includes a common electrode layer 11. The common electrode layer 11 is provided with a plurality of slits 111 and a plurality of electrode parts 110. The plurality of slits 111 are arrayed, and one electrode part 110 exists between any two adjacent slits 111.

As illustrated in FIG. 1, the plurality of slits 111 include a first slit 1111 and a second slit 1112 that are adjacent to each other. A first electrode part 1101 is disposed between the first slit 1111 and the second slit 1112. An orthographic projection of the first electrode part 1101 on the color film layer 21 is at least partially overlapped with an orthographic projection of a first light-shielding part 2201 on the color film layer 21. The first slit 1111 and the second slit 1112 are any two adjacent slits of the plurality of slits 111.

In some embodiments, in an arrangement direction of the first slit 1111 and the second slit 1112, the width of the first electrode part 1101 is greater than the width of the first light-shielding part 2201, and this design is conducive to improving the stability of the aperture ratio with process fluctuations. Alternatively, in an arrangement direction of the first slit 1111 and the second slit 1112, the width of the first electrode part 1101 is less than or equal to the width of the first light-shielding part 2201, and this design is beneficial to reducing the overall reflectance of the liquid crystal display panel. The arrangement direction of the first slit 1111 and the second slit 1112 is the x direction or y direction.

In some embodiments, the common electrode layer 11 is made of a metal material. Since the metal material is generally opaque, the electrode part 110 may block light rays, thereby reducing the possibility of color crosstalk. For example, the metal material includes, but is not limited to, silver, gold, copper, molybdenum, and the like.

In some practices, the color film substrate includes a black matrix and a color film layer. The black matrix and the color film layer are arranged in the same layer, that is, both the black matrix and the color resistance blocks in the color film layer are in contact with the same face of the transparent substrate of the color film substrate. However, in the embodiments of the present disclosure, the black matrix is disposed on the side of the color film layer proximal to the array substrate. Therefore, the distance between the black matrix 22 and the common electrode layer 11 in the embodiments of the present disclosure is smaller than the distance between the black matrix and the common electrode layer in some practices.

In the case where light rays are incident from the side of the array substrate 1 and sequentially pass through the array substrate 1, the liquid crystal layer 3, and the color film substrate 2, it is necessary to reduce light rays emitted upon passing through two adjacent color resistance blocks to prevent color crosstalk. In the case where the distance between the black matrix 22 and the common electrode layer 11 is larger, the width of the black matrix at the junction of two adjacent color resistance blocks 220 is larger, so as to prevent the light rays from being emitted upon passing through the two adjacent color resistance blocks. In the embodiments of the present disclosure, the width of the black matrix 22 at the junction of two adjacent color resistance blocks 220 is reduced by reducing the distance between the black matrix 22 and the common electrode layer 11, such that the area of the opening region of the black matrix 22 is larger, and the higher pixel aperture ratio is achieved.

In the embodiments of the present disclosure, the width of the first light-shielding part 2201 is determined based on the width of the first electrode part 1101 and the distance between the black matrix 22 and the common electrode layer 11 (i.e., the distance between the first light-shielding part 2201 and the first electrode part 1101).

FIG. 4 is a schematic diagram illustrating a relationship between a target angle, a target distance, a first light-shielding part, and a first electrode part according to some embodiments of the present disclosure. As illustrated in FIG. 4, the target distance L is a distance between the first light-shielding part 2201 and the first electrode part 1101. In some embodiments, the target distance L is a distance from the face of the first light-shielding part 2201 proximal to the first electrode part 1101 to the face of the first electrode part 1101 proximal to the first light-shielding part 2201. Since the thickness of the first light-shielding part 2201 and the thickness of the first electrode part 1101 are very small relative to the target distance L, the thickness of the first light-shielding part 2201 and the thickness of the first electrode part 1101 may be neglected.

The target angle θ is an angle between a connection line between projections of a first side edge of the first electrode part 1101 and a second side edge of the first light-shielding part 2201 on a reference plane and a thickness direction z of the liquid crystal display panel, and the reference plane is perpendicular to the first side edge and the second side edge. Therefore, the projections of the first side edge and the second side edge on the reference plane are both a point. In the embodiments of the present disclosure, the reference plane is a virtual plane, and is any plane perpendicular to the first side edge and the second side edge. In the arrangement direction of the first slit 1111 and the second slit 1112, the first side edge is the side proximal to the first slit 1111, and the second side edge is the side proximal to the second slit 1112.

The relationship between the target angle θ, the target distance L, the width d of the first light-shielding part 2201, and the width D of the first electrode part 1101 satisfies Formula (1):

$$\frac{d}{tan θ} + \frac{D - d}{2 * tan θ} = L . \qquad ( 1 )$$

Based on Formula (1), Formula (2) is obtained:

D+d=2L*tanθ (2).

That is, the ratio of the sum of the width d of the first light-shielding part 2201 and the width D of the first electrode part 1101 to twice the target distance L is equal to the tangent value of the target angle θ. The target angle θ is determined based on the maximum viewing angle of the liquid crystal display panel. The viewing angle of the liquid crystal display panel refers to an angle α between a light ray emitted from the color film substrate 2 and the direction perpendicular to the color film layer 21. In the implementations, the maximum viewing angle of the liquid crystal display panel (that is, a corresponding maximum viewing angle in the case of no color crosstalk, for example, 30° or the like) is determined based on product requirements, and then the target angle θ is determined based on refractive indexes of the layers of the liquid crystal display panel. In the case where the condition is satisfied, the light rays may be prevented from entering the human eye upon sequentially passing through two adjacent color resistance blocks, thereby preventing color crosstalk.

It may be seen from Formula (2) that the sum of the width d of the first light-shielding part 2201 and the width D of the first electrode part 1101 is positively correlated with the target distance L. In the case where the width D of the first electrode part 1101 and the target angle θ are fixed, the width d of the first light-shielding part 2201 is positively correlated with the target distance L. That is, in the case where the target distance L is larger, the width d of the first light-shielding part 2201 is larger. Therefore, the width d of the first light-shielding part 2201 is reduced by reducing the target distance L, such that the pixel aperture ratio is increased.

Taking a liquid crystal display panel with a pixel pitch of 6 μm as an example, in the case where it is necessary to ensure that no color crosstalk occurs at a viewing angle of 30°, the sum of the width d of the first light-shielding part 2201 and the width D of the first electrode part 1101 is equal to 3.7 μm in some practices, while the sum of the width d of the first light-shielding part 2201 and the width D of the first electrode part 1101 is 2.7 μm in the embodiments of the present disclosure. It can be seen that the pixel aperture ratio effectively increases in the embodiments of the present disclosure.

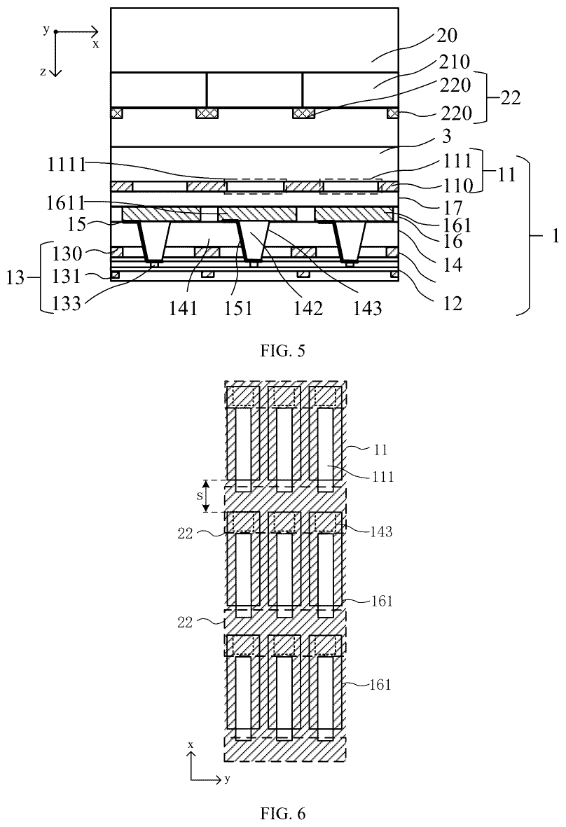

FIG. 5 is a schematic diagram of a cross-sectional structure of another liquid crystal display panel according to some embodiments of the present disclosure. As illustrated in FIG. 5, the array substrate 1 further includes a base substrate 12, a drive circuit layer 13, a planarization layer 14, a connection electrode layer 15, a pixel electrode layer 16, and an insulating layer 17. The base substrate 12, the drive circuit layer 13, the planarization layer 14, the pixel electrode layer 16, the insulating layer 17, and the common electrode layer 11 are sequentially stacked.

The pixel electrode layer 16 includes a plurality of arrayed pixel electrodes 161, and is configured to form an electric field with the common electrode layer 11. The electric field is configured to control the deflection of liquid crystal molecules in the liquid crystal layer.

The drive circuit layer 13 includes a plurality of arrayed pixel drive circuits (not illustrated in the figure). Each of the pixel drive circuits is electrically connected to one pixel electrode 161. Each of the pixel drive circuits includes at least one thin film transistor (TFT). The embodiments of the present disclosure do not limit the layer structure of the drive circuit layer 13. For example, the drive circuit layer includes an active layer, a gate insulating layer, a gate layer, an interlayer dielectric layer, and a source-drain layer that are sequentially stacked on the base substrate 12. Materials of the layers may be selected as required, which is not limited in the embodiments of the present disclosure.

As illustrated in FIG. 5, the drive circuit layer 13 includes a plurality of wires 130. The influence of the plurality of wires 130 on light rays passing through the drive circuit layer needs to be as small as possible. Therefore, the plurality of wires 130 are arranged under the plurality of electrode parts 110 as much as possible. That is, orthographic projections of the plurality of wires 130 on a carrying face of the base substrate 12 are at least partially overlapped with orthographic projections of the plurality of electrode parts 110 on the carrying face of the base substrate 12. The wire 130 refers to a wire having an light blocking effect in the drive circuit layer 13, for example, a data line disposed on the source-drain layer.

FIG. 6 is a schematic diagram of a planar structure of a liquid crystal display panel in some practices. As illustrated in FIG. 6, in some practices, a plurality of through holes 143 are provided in the planarization layer 14, and the pixel electrode 161 includes a part disposed on a face of the planarization layer 14 other than the through hole 143, a part disposed on a sidewall of the through hole 143, and a part disposed on a corresponding pixel drive circuit in the drive circuit layer 13, such that each pixel electrode 161 is connected to the corresponding pixel drive circuit through one through hole 143. However, the pixel electrode layer 16 at the through hole 143 is not flat, such that the thickness of the liquid crystal layer 3 at the via hole is different from the thickness of the liquid crystal layer 3 at positions other than the through hole 143. Due to the uneven thickness of the liquid crystal layer 3, the disordered liquid crystal alignment at the through hole 143 may cause dark-state light leakage. Therefore, the through holes 143 need to be arranged under the black matrix 22.

Since a minimum spacing s is required between two adjacent pixel electrodes 161, in the case where the size of the pixel electrode 161 is fixed, for example, in the x direction illustrated in FIG. 6, the pixel electrode 161 may not cover the slit 111 completely, and one end of the slit 111 is not overlapped with the pixel electrode 161. A small overlapping region between the pixel electrode 161 and the electrode part 110 may result in the low liquid crystal efficiency, which in turn affects the light efficiency.

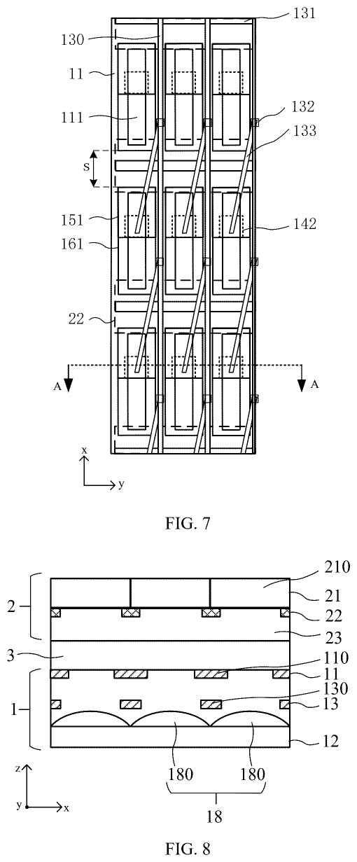

FIG. 7 is a schematic diagram of a planar structure of a liquid crystal display panel according to some embodiments of the present disclosure, and FIG. 5 is a schematic diagram of a cross-sectional structure taken along a line AA in FIG. 7. As illustrated in FIG. 5 and FIG. 7, the planarization layer 14 includes a body part 141 provided with a plurality of through holes (such as first through holes 143) and a plurality of filling structures 142 disposed in the plurality of through holes. The plurality of filling structures 142 in the planarization layer 14 may level the through holes, thereby alleviating light leakage caused by the uneven thickness of the liquid crystal layer 3 at the through holes. In this case, the through holes are not limited to being arranged under the black matrix. That is, orthographic projections of the filling structures 142 on the carrying face of the base substrate 12 at least partially are not overlapped with an orthographic projection of the black matrix 22 on the carrying face of the base substrate 12.

In some embodiments, as illustrated in FIG. 7, the orthographic projections of the filling structure 142 on the carrying face of the base substrate 12 are not overlapped with the orthographic projection of the black matrix 22 on the carrying face of the base substrate 12. That is, the orthographic projections of the filling structures 142 on the carrying face of the base substrate 12 is within an orthographic projection of one color resistance block on the carrying face of the base substrate 12.

In the embodiments of the present disclosure, referring to FIG. 5, the connection electrode layer 15 includes a plurality of connection electrodes. The connection electrodes are in one-to-one correspondence with the pixel electrodes 161. Taking any one of the plurality of connection electrodes as the first connection electrode 151, a portion of the first connection electrode 151 is disposed in the first through hole 143 of the plurality of through holes and is electrically connected to the drive circuit layer 13. Another portion of the first connection electrode 151 is disposed on the side of the planarization layer 14 distal from the base substrate 12 and is connected to a first pixel electrode 1611 of the plurality of pixel electrodes 161. The first pixel electrode 1611 covers the portion of the first connection electrode 151 disposed on the side of the planarization layer 14 distal from the base substrate 12 and the filling structure 142 in the first through hole 143.

Since the plurality of filling structures 142 in the planarization layer 14 level the through holes, the connection electrode layer 15 in the embodiments of the present disclosure undertakes the function originally achieved by the portion of the pixel electrode 161 disposed on the sidewall of the through hole 143 and the function originally achieved by the portion of the pixel electrode 161 disposed on the corresponding pixel drive circuit in the drive circuit layer 13 in some practices, such that the pixel electrode 161 is connected to the drive circuit layer 13. That is, by disposing the connection electrode layers 15, the problem of missing connection between the pixel electrode 161 and the drive circuit layer 13 upon addition of the filling structures 142 is avoided. As illustrated in FIG. 5, the first connection electrode 151 extends from the side of the planarization layer 14 proximal to the base substrate 12 to the side of the planarization layer distal from the base substrate 12, such that the first pixel electrode 1611, the first connection electrode 151, and the drive circuit layer 13 are electrically connected sequentially. That is, the drive circuit layer 13 is electrically connected to the pixel electrode layer 16 through the connection electrode layer 15, such that the pixel electrode layer 16 and the common electrode layer 11 jointly form an electric field acting on the liquid crystal layer 3, such that the display function is achieved.

In some embodiments, with reference to FIG. 5 and FIG. 7, the drive circuit layer 13 includes a gate electrode layer, an active layer, and a source-drain layer that are sequentially stacked on the base substrate 12. An insulating layer (also referred to as a gate insulating layer) is provided between the gate electrode layer and the active layer, and an insulating layer (also referred to as an interlayer dielectric layer) is provided between the active layer and the source-drain layer. The gate electrode layer includes a plurality of gate lines 131. The plurality of gate lines 131 are arranged along the first direction x, and an extending direction of the gate lines 131 is the second direction y. The source-drain layer includes a plurality of data lines (wires 130). The plurality of data lines 130 are arranged along the second direction y, and an extending direction of the data lines 130 is the first direction x. The plurality of gate lines 131 intersect the plurality of data lines 130.

The active layer includes a plurality of active regions 133. The plurality of active regions are arrayed. In some embodiments, the active regions 133 extend from positions under the filling structures 142 of the planarization layer 14 to the data lines 130, and are electrically connected to the data lines 130 through via holes 132 in the interlayer dielectric layer. The active regions 133 pass positions above the gate line 131. The “above” refers to the direction distal from the base substrate, and the “under” refers to the direction proximal to the base substrate.

In some embodiments, as illustrated in FIG. 7, the active regions 133 are strip-shaped.

In some embodiments, as illustrated in FIG. 7, the active regions 133 are made of a semiconductor material, and the active regions 133 are conducted in the case where a current passes through the gate lines under the active regions 133.

The gate layer, the gate insulating layer, the active layer, the interlayer dielectric layer, and the source-drain layer are sequentially stacked to form a plurality of TFTs. The plurality of TFTs are disposed at a plurality of intersections formed by a plurality of gate lines 131 and a plurality of data lines 130. In some embodiments, the plurality of TFTs are in one-to-one correspondence with and electrically connected to the plurality of pixel electrodes 161 through the active regions 133, and the TFTs control the connected pixel electrodes.

In some embodiments, referring to FIG. 5, the plurality of through holes (for example, the first through holes 143) in the planarization layer 14 penetrate through the planarization layer 14 and the insulating layer in the drive circuit layer 13 disposed on the side of the source-drain layer (on which the wires 130 are disposed) proximal to the base substrate 12 and reach the active regions 133. The filling structures 142 penetrate the planarization layer 14 and the insulating layer in the drive circuit layer 13 disposed on the side of the source-drain layer (on which the wires 130 are disposed) proximal to the base substrate 12. In this way, a portion of the first connection electrode 151 is disposed in the first through hole 143 of the plurality of through holes, and is electrically connected to the drive circuit layer 13. The first connection electrode 151 is electrically connected to the drive circuit layer 13, that is, the first connection electrode 151 is electrically connected to the active region 133 in the drive circuit layer 13.

In some embodiments, the base substrate 12 is made of glass or quartz.

The active layer 133 is made of one of metal oxide and low-temperature polycrystalline silicon (also referred to as p-Si). In some embodiments, the gate layer is a single-layer metal thin film of molybdenum, copper, titanium, or the like, or is a molybdenum layer, an aluminum layer, and a molybdenum layer that are sequentially stacked, or a multi-layer metal thin film of a titanium layer, an aluminum layer, and a titanium layer that are sequentially stacked. The gate insulating layer or the insulating layer is made of silicon oxide, silicon nitride, or silicon oxynitride. In some embodiments, the source-drain layer is a single-layer metal thin film of aluminum, molybdenum, copper, titanium, or the like, or is a molybdenum layer, an aluminum layer, and a molybdenum layer that are sequentially stacked, or a multi-layer metal thin film of a titanium layer, an aluminum layer, and a titanium layer that are sequentially stacked.

In some embodiments, the planarization layer 14 is made of silicon nitride, silicon oxynitride, or an epoxy resin. In some embodiments, the connection electrode layer 15 is made of a transparent conductive material, such as indium tin oxide (ITO) or indium zinc oxide (IZO). The connection electrode layer made of the transparent conductive material facilitates the penetration of light rays.

In some embodiments, the pixel electrode layer 16 is made of a transparent conductive material, such as indium tin oxide (ITO) or indium zinc oxide (IZO). The pixel electrode layer made of the transparent conductive material facilitates the penetration of light rays.

In some embodiments, the insulating layer 17 is made of silicon oxide, silicon nitride, or silicon oxynitride.

In some embodiments, as illustrated in FIG. 7, the common electrode layer 11 includes a plurality of arrayed slits 111 along the x direction and the y direction. The plurality of slits 111 arranged in the x direction are referred to as slits in the same row, and the plurality of slits 111 arranged in the y direction are referred to as slits in the same column. The plurality of slits 111 are in one-to-one correspondence with the plurality of pixel electrodes 161. An orthographic projection of each of the slits 111 on the carrying face of the base substrate 12 is within an orthographic projection of the corresponding pixel electrode 161 on the carrying face. For example, an orthographic projection of the first slit 1111 on the carrying face of the base substrate 12 is within an orthographic projection of the first pixel electrode 1611 on the carrying face.

In some other embodiments, in the common electrode layer 11, the slits in the same column along the y direction are in communication with each other to form a larger-sized slit in the y direction. The y direction is a length direction of the slit. One slit 111 corresponds to a plurality of pixel electrodes 161, that is, an orthographic projection of each of the slits 111 on the carrying face of the base substrate 12 is overlapped with orthographic projections of a plurality of consecutive pixel electrodes 161 arranged in the y direction on the carrying face of the base substrate 12.

FIG. 8 is a schematic diagram of a cross-sectional structure of another liquid crystal display panel according to some embodiments of the present disclosure. As illustrated in FIG. 8, the array substrate 11 further includes a dimming assembly 18. The dimming assembly 18 is disposed between the base substrate 12 and the drive circuit layer 13.

The dimming assembly 18 is configured to deflect, to the color film layer 21, light rays that are in light rays emitted by a backlight assembly and that irradiate the plurality of wires 130, the plurality of electrode parts 110, or the black matrix 22.

By disposing the dimming assembly 18, a portion of light rays that are emitted by the backlight assembly and irradiate in opaque regions including the wires in the drive circuit layer 13, the electrode parts in the common electrode layer 11, and the black matrix 22 may be deflected to the color film layer 21, such that much light rays pass through the color film layer 21, and the light utilization rate of the liquid crystal display panel and the display effect are improved.

In some embodiments, the plurality of wires 130 are disposed in the conductive layer in the drive circuit layer 13 that is most proximal to the pixel electrode layer 16, such as the source-drain layer. The wires 130 extend along the y direction.

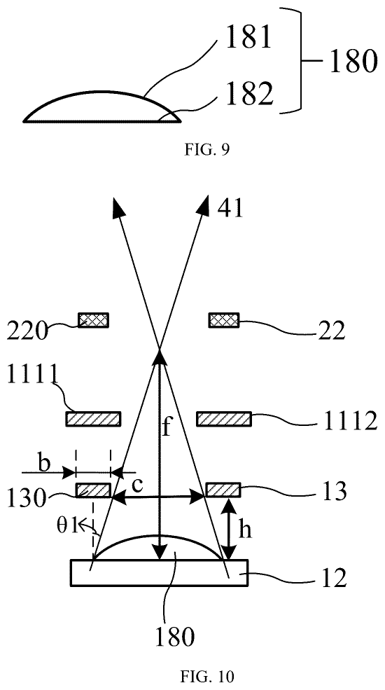

FIG. 9 is a schematic structural diagram of a lens according to some embodiments of the present disclosure. As illustrated in FIG. 8 and FIG. 9, the dimming assembly 18 includes a plurality of lenses 180. The plurality of lenses 180 are in one-to-one correspondence with the plurality of color resistance blocks 210. An orthographic projection of each of the lenses 180 on the carrying face of the base substrate 12 is at least partially overlapped with an orthographic projection of the corresponding color resistance block 210 on the carrying face.

In some embodiments, the lens 180 includes a top face 181 and a bottom face 182. The top face 181 is an arc face protruding in a direction away from the base substrate 12, and the bottom face 182 is parallel to the carrying face of the base substrate 12.

The lens 180 may converge light rays (including light rays directed toward the black matrix 22) directed toward the vicinity of the corresponding color resistance block 210 toward the middle of the color resistance block 210, such that the light utilization rate of the liquid crystal display panel and the display effect are improved.

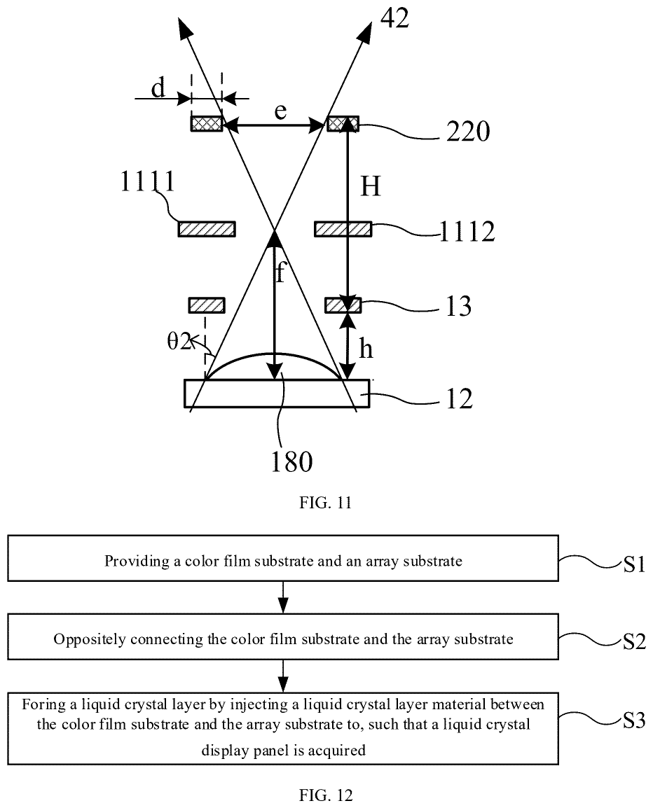

FIG. 10 is a schematic diagram of a light path of a liquid crystal display panel including a lens according to some embodiments of the present disclosure. FIG. 11 is a schematic diagram of a light path of another liquid crystal display panel including a lens according to some embodiments of the present disclosure. As illustrated in FIG. 10 and FIG. 11, the focal length f of the lens is less than h*(b+c)/b and greater than (H+h)*(e+d)/(2e+d).

In FIG. 10, b represents the width of the wire in the drive circuit layer 13 in the arrangement direction of the first slit 1111 and the second slit 1112, c represents the distance between two adjacent wires in the arrangement direction of the first slit 1111 and the second slit 1112, and h represents the distance between the side of a target wire proximal to the base substrate 12 and the bottom face of the lens 180. In FIG. 11, d represents the width of the light-shielding part 220 in the arrangement direction of the first slit 1111 and the second slit 1112, e represents the width of the opening region in the arrangement direction of the first slit 1111 and the second slit 1112, H represents the distance between the side of a target wire proximal to the base substrate 12 and the side of a target light-shielding part 220 distal from the base substrate, and h represents the distance between the side of a target wire proximal to the base substrate 12 and the bottom face of the lens 180.

In the case where the focal length of the lens 180 satisfies the relationship, light rays directed toward the black matrix 22, the wires of the drive circuit layer 13, or the common electrode layer 11 are deflected as much as possible and pass through the color film layer 21, such that the light efficiency of the liquid crystal display panel is further improved.

In the embodiments of the present disclosure, the distance between the side of the wire in the drive circuit layer 13 proximal to the base substrate 12 and the edge of the bottom face of the lens 180 satisfies that the deflection angle is greater than or equal to a first angle θ1 and less than or equal to a second angle θ2. The deflection angle is an angle between the direction of the deflected light rays from the light rays emitted by the backlight assembly upon passing through the lens and the direction perpendicular to the carrying face of the base substrate.

In the embodiments illustrated in FIG. 10, the first angle θ1 is an angle between a connection line 41 between the edge of the bottom face of a target lens and the edge of the side of a target wire proximal to the base substrate 12 and the direction perpendicular to the carrying face of the base substrate 12. The target lens is any one of the plurality of lenses 180, and the target wire 130 is a wire in the plurality of wires in the drive circuit layer 13 that is most proximal to the target lens.

In the embodiments illustrated in FIG. 11, the second angle θ2 is an angle between a connection line 42 between the edge of the bottom face of a target lens and the edge of the side of a target light-shielding part distal from the base substrate 12 and the direction perpendicular to the carrying face of the base substrate 12. The target light-shielding part is a light-shielding part in the plurality of light-shielding parts 220 that is most proximal to the target lens, and an extending direction of the target light-shielding part is the same as an extending direction of the target wire. That is, the target light-shielding part may block a segment of the target wire.

FIG. 10 and FIG. 11 illustrate two boundary states in which the light efficiency is maximized (light rays are not blocked). As illustrated in FIG. 10 and FIG. 11, the first angle θ1 represents a critical state in which light rays are not blocked by the plurality of wires 130 in the drive circuit layer 13 and needs to satisfy: tanθ1=b/(2h); and the second angle θ2 represents a critical state in which light rays are not blocked by the light-shielding part 220 and needs to satisfy: tanθ2=(2e+d)/(2H+2h). It can be seen that only in the case where the first angle θ1 and the second angle θ2 satisfy the relationship with the black matrix 22, the wires 130 in the drive circuit layer 13, and the lens 180, can the light rays be emitted from the color film substrate 2. b represents the width of the wire in the drive circuit layer 13 in the arrangement direction of the first slit 1111 and the second slit 1112, e represents the width of the opening region in the arrangement direction of the first slit 1111 and the second slit 1112, d represents the width of the light-shielding part 220 in the arrangement direction of the first slit 1111 and the second slit 1112, H represents the distance between the side of a target wire proximal to the base substrate 12 and the side of the target light-shielding part distal from the base substrate, and h represents the distance between the side of the target wire proximal to the base substrate 12 and the bottom face of the lens 180.

FIG. 12 is a flowchart of a method for manufacturing a liquid crystal display panel according to some embodiments of the present disclosure. The method is used for preparing the liquid crystal display panel illustrated in FIG. 5. As illustrated in FIG. 12, the method includes the following processes.

In S1, a color film substrate and an array substrate are provided. The color film substrate includes a color film layer and a black matrix. The color film layer includes a plurality of arrayed color resistance blocks, the black matrix is disposed on a side of the color film layer, and the black matrix includes a plurality of light-shielding parts. Orthographic projections of the plurality of light-shielding parts on the color film layer are located at junctions of the plurality of color resistance blocks. The array substrate includes a common electrode layer. The common electrode layer is provided with a plurality arrayed of slits, and the common electrode layer includes a plurality of electrode parts. The plurality of electrode parts include a first electrode part disposed between a first slit and a second slit.

In S2, the color film substrate and the array substrate are connected opposite to each other. In S2, an orthographic projection of the first electrode part on the color film layer is at least partially overlapped with an orthographic projection of the first light-shielding part on the color film layer. The first slit and the second slit are two adjacent slits of the plurality of slits.

In S3, a liquid crystal layer is acquired by injecting a liquid crystal layer material between the color film substrate and the array substrate, such that a liquid crystal display panel is acquired.

In some embodiments, in S1, providing the color film substrate includes: forming a color film layer on a side of a transparent substrate, and forming a black matrix on the transparent substrate on which the color film layer is formed.

In some embodiments, in S1, providing the array substrate includes the following processes.

In a first step, an initial gate metal layer is formed on a base substrate, a photoresist structure is acquired through photoresist coating, exposure, and development, and the initial gate metal layer is etched using the photoresist structure as a mask to acquire a gate layer. The gate layer includes a plurality of gate lines. A gate insulating layer is formed on the gate layer.

In a second step, a semiconductor material layer is formed on the gate insulating layer, a photoresist structure is acquired through photoresist coating, exposure, and development, and the semiconductor material layer is etched using the photoresist structure as a mask to acquire an active layer. The active layer includes a plurality of strip-shaped active regions.

In a third step, an initial interlayer dielectric layer is formed on the active layer, and a plurality of via holes exposing the active regions are formed through a series of processes such as photoresist coating, exposure, etching, and stripping, such that an interlayer dielectric layer is acquired. A source-drain metal layer is formed on the interlayer dielectric layer, and a source-drain layer is acquired through a series of processes such as photoresist coating, exposure, etching, and stripping. The source-drain layer includes a plurality of data lines. The data lines in the source-drain layer are connected to the active regions through the via holes in the interlayer dielectric layer. In this way, a drive circuit layer is acquired.

In a fourth step, a body part of the planarization layer provided with a plurality of through holes is formed on the drive circuit layer through a series of processes such as photoresist coating, exposure, and development. The plurality of through holes penetrate through the planarization layer and the active layer, and expose the active regions.

In a fifth step, a plurality of first portion of connection electrodes, a plurality of second portion of connection electrodes, and a plurality of third portion of connection electrodes are formed in the plurality of through holes through a series of processes such as photoresist coating and exposure. Each of the first portion of connection electrodes is disposed at the bottom of the through hole and is electrically connected to the data line in the source-drain layer through the active region. The plurality of second portion of connection electrodes are all disposed on the sidewall of the through holes and are connected to the plurality of first portion of connection electrodes. The plurality of third portion of connection electrodes are disposed on the body part of the planarization layer and are connected to the plurality of second portion of connection electrode. In this way, a connection electrode layer is acquired.

In a sixth step, a plurality of filling structures are formed in the plurality of through holes, and faces of the filling structures are flush with a face of the body part of the planarization layer. In this way, a planarization layer is acquired.

In a seventh step, a plurality of pixel electrodes are formed on faces of the planarization layer and the plurality of third portion of connection electrodes through a series of processes such as photoresist coating, exposure, etching, and stripping. The plurality of pixel electrodes cover the plurality of third portion of connection electrodes and the plurality of filling structures, and the plurality of pixel electrodes are electrically connected to the plurality of third portion of connection electrode s. In this way, a pixel electrode layer is acquired.

In an eighth step, an insulating layer is formed on the pixel electrode layer, and a common electrode layer provided with a plurality of slits is formed on the insulating layer through a series of processes such as photoresist coating, exposure, etching, and stripping. In this way, an array substrate is acquired.

In some embodiments, in S2, the color film substrate and the array substrate are connected opposite to each other using a frame sealing adhesive through coating, heat curing, or ultraviolet curing. The frame sealing adhesive adheres and fixes the array substrate and the color film substrate, and further prevents the liquid crystal layer material from flowing out.

In some embodiments, the main components of the frame sealing adhesive include a resin, and the type of the resin includes a thermosetting type and a photocurable type. In practice, a frame sealing adhesive mixed by a thermosetting material and a photocurable material is mostly used. The main components include an ultraviolet (UV) curable resin, a UV curing initiator, a thermosetting resin, a thermosetting agent, a coupling agent, and the like.

In some embodiments, in S2, the liquid crystal layer material is injected into the space defined by the color film substrate and the array substrate by one drop filling (ODF).

The liquid crystal display panel according to the embodiments of the present disclosure is particularly suitable for display apparatuses with high pixels per inch (PPI), including but not limited to a virtual reality (VR) display apparatus.

The embodiments of the present disclosure further provide a liquid crystal display device. The liquid crystal display device includes any one of the foregoing liquid crystal display panels and a backlight assembly. The backlight assembly is configured to provide a light source for the liquid crystal display panel.

In some embodiments, the liquid crystal display device further includes a power supply circuit. The power supply circuit is configured to supply power to the liquid crystal display panel and the backlight assembly.

In some embodiments, the display device according to the embodiments of the present disclosure is any product or component having a display function, such as a mobile phone, a tablet computer, a television, a display, a notebook computer, a digital photo frame, or a navigator.

The liquid crystal display device has the same effect as the foregoing liquid crystal display panels, and details will not be repeated herein.

Described above are merely optional embodiments of the present disclosure and are not intended to limit the present disclosure. Any modifications, equivalent substitutions, improvements, and the like, made within the spirit and principle of the present disclosure, shall be included in the scope of protection of the present disclosure.

1. A liquid crystal display panel, comprising: an array substrate, a color film substrate, and a liquid crystal layer, wherein the array substrate and the color film substrate are connected opposite to each other, and the liquid crystal layer is disposed between the array substrate and the color film substrate;
the color film substrate comprises a color film layer and a black matrix, wherein the color film layer comprises a plurality of arrayed color resistance blocks, the black matrix is disposed on a side of the color film layer proximal to the array substrate, and the black matrix comprises a plurality of light-shielding parts, wherein orthographic projections of the plurality of light-shielding parts on the color film layer are located at junctions of the plurality of color resistance blocks; and
the array substrate comprises a common electrode layer, wherein the common electrode layer is provided with a plurality of arrayed slits, and comprises a plurality of electrode parts, wherein the plurality of electrode parts comprise a first electrode part disposed between a first slit and a second slit, an orthographic projection of the first electrode part on the color film layer is at least partially overlapped with an orthographic projection of a first light-shielding part on the color film layer, and the first slit and the second slit are two adjacent slits of the plurality of slits.

2. The liquid crystal display panel according to claim 1, wherein a ratio of a sum of a width of the first light-shielding part and a width of the first electrode part to twice a target distance is equal to a tangent value of a target angle, wherein
the target angle is determined based on a maximum viewing angle of the liquid crystal display panel;
the target distance is a distance between the first light-shielding part and the first electrode part;
the target angle is an angle between a connection line between projections of a first side edge of the first electrode part and a second side edge of the first light-shielding part in a reference plane and a thickness direction of the liquid crystal display panel, wherein the reference plane is perpendicular to the first side edge and the second side edge; and in an arrangement direction of the first slit and the second slit, the first side edge is a side edge proximal to the first slit, and the second side edge is a side edge proximal to the second slit.

3. The liquid crystal display panel according to claim 2, wherein the common electrode layer is made of a metal material.

4. The liquid crystal display panel according to claim 1, wherein the array substrate further comprises a base substrate, a drive circuit layer, a planarization layer, a connection electrode layer, a pixel electrode layer, and an insulating layer, wherein the base substrate, the drive circuit layer, the planarization layer, the pixel electrode layer, the insulating layer, and the common electrode layer are sequentially stacked;
the planarization layer comprises a body part provided with a plurality of through holes and a plurality of filling structures in the plurality of through holes, and the pixel electrode layer comprises a plurality of arrayed pixel electrodes;
the connection electrode layer comprises a plurality of connection electrodes, a portion of a first connection electrode in the plurality of connection electrodes is disposed in a first through hole in the plurality of through holes and is electrically connected to the drive circuit layer, and another portion of the first connection electrode is disposed on a side of the planarization layer distal from the base substrate and is connected to a first pixel electrode in the plurality of pixel electrodes, wherein the first pixel electrode covers the first connection electrode and the plurality of filling structures in the first through hole.

5. The liquid crystal display panel according to claim 4, wherein orthographic projections of the plurality of filling structures on a carrying face of the base substrate are at least partially not overlapped with an orthographic projection of the black matrix on the carrying face of the base substrate.

6. The liquid crystal display panel according to claim 5, wherein
an orthographic projection of the first slit on the carrying face of the base substrate is within an orthographic projection of the first pixel electrode on the carrying face of the base substrate; or
an orthographic projection of the first slit on the carrying face of the base substrate is at least partially overlapped with orthographic projections of a plurality of continuous pixel electrodes arranged in a first direction on the carrying face of the base substrate, wherein the first direction is a length direction of the first slit.

7. The liquid crystal display panel according to claim 5, wherein the connection electrode layer and the pixel electrode layer are both made of a transparent conductive material.

8. The liquid crystal display panel according to claim 1, wherein
the array substrate further comprises a dimming assembly, wherein the dimming assembly is disposed between the base substrate and the drive circuit layer;
the drive circuit layer comprises a plurality of wires, wherein an orthographic projection of each of the plurality of wires on the carrying face of the base substrate is at least partially overlapped with an orthographic projection of one of the plurality of electrode parts on the carrying face of the base substrate;
the dimming assembly is configured to deflect, to the color film layer, light rays that are in light rays incident to the liquid crystal display panel from a side of the array substrate and irradiate the plurality of wires, the plurality of electrode parts, or the black matrix.

9. The liquid crystal display panel according to claim 8, wherein the dimming assembly comprises a plurality of lenses, wherein the plurality of lenses are in one-to-one correspondence with the plurality of color resistance blocks, and orthographic projections of corresponding lenses and color resistance blocks on the carrying face of the base substrate are at least partially overlapped with each other.

10. The liquid crystal display panel according to claim 9, wherein each of the plurality of lenses comprises a top face and a bottom face, wherein the top face is an arc face protruding in a direction away from the base substrate, and the bottom face is connected to the carrying face of the base substrate.

11. The liquid crystal display panel according to claim 9, wherein a focal length of each of the plurality of lenses is less than h*(b+c)/b and greater than (H+h)*(e+d)/(2e+d),
wherein b represents a width of each of the plurality of wires in an arrangement direction of the first slit and the second slit, c represents a distance between two adjacent wires of the plurality of wires in the arrangement direction, d represents a width of each of the plurality of light-shielding parts in the arrangement direction, e represents a width of an opening region in the arrangement direction, H represents a distance between a side of a target wire proximal to the base substrate and a side of a target light-shielding part distal from the base substrate, and h represents a distance between the side of the target wire proximal to the base substrate and a bottom face of the lens;
wherein the target lens is any one of the plurality of lenses, the target wire is a wire that is most proximal to the target lens in the plurality of wires in the drive circuit layer, and the target light-shielding part is a light-shielding part that is most proximal to the target lens in the plurality of light-shielding parts.

12. The liquid crystal display panel according to claim 11, wherein a distance between the drive circuit layer and the bottom face of the lens satisfies that a deflection angle is greater than or equal to a first angle and less than or equal to a second angle,
wherein the deflection angle is an angle between an emergent direction of an incident light ray upon passing through one of the plurality of lenses and a direction perpendicular to the carrying face of the base substrate, the first angle is an angle between a connection line between an edge of a bottom face of the target lens and an edge of the side of the target wire proximal to the base substrate and the direction perpendicular to the carrying face of the base substrate, and the second angle is an angle between a connection line between the edge of the bottom face of the target lens and an edge of the side of the target light-shielding part distal from the base substrate and the direction perpendicular to the carrying face of the base substrate.

13. The liquid crystal display panel according to claim 12, wherein
the first angle satisfies that tanθ1=b/(2h);
the second angle satisfies that tanθ2=(2e+d)/(2H+2h),
wherein θ1 represents the first angle, and θ2 represents the second angle.

14. A liquid crystal display device, comprising: a backlight assembly and a liquid crystal display panel, wherein
the liquid crystal display panel comprises: an array substrate, a color film substrate, and a liquid crystal layer, wherein
the array substrate and the color film substrate are connected opposite to each other, and the liquid crystal layer is disposed between the array substrate and the color film substrate;
the color film substrate comprises a color film layer and a black matrix, wherein the color film layer comprises a plurality of arrayed color resistance blocks, the black matrix is disposed on a side of the color film layer proximal to the array substrate, and the black matrix comprises a plurality of light-shielding parts, wherein orthographic projections of the plurality of light-shielding parts on the color film layer are located at junctions of the plurality of color resistance blocks; and
the array substrate comprises a common electrode layer, wherein the common electrode layer is provided with a plurality of arrayed slits, and comprises a plurality of electrode parts, wherein the plurality of electrode parts comprise a first electrode part disposed between a first slit and a second slit, an orthographic projection of the first electrode part on the color film layer is at least partially overlapped with an orthographic projection of a first light-shielding part on the color film layer, and the first slit and the second slit are two adjacent slits of the plurality of slits; and
the backlight assembly is configured to provide a light source for the liquid crystal display panel.

15. A method for manufacturing a liquid crystal display panel, comprising:
providing an array substrate and a color film substrate, wherein the color film substrate comprises a color film layer and a black matrix, wherein the color film layer comprises a plurality of arrayed color resistance blocks, the black matrix is disposed on a side of the color film layer proximal to the array substrate, and the black matrix comprises a plurality of light-shielding parts, wherein orthographic projections of the plurality of light-shielding parts on the color film layer are located at junctions of the plurality of color resistance blocks; and the array substrate comprises a common electrode layer, wherein the common electrode layer is provided with a plurality of arrayed slits and comprises a plurality of electrode parts, wherein the plurality of electrode parts comprise a first electrode part disposed between a first slit and a second slit, and the first slit and the second slit are two adjacent slits of the plurality of slits;
oppositely connecting the array substrate and the color film substrate, such that an orthographic projection of the first electrode part on the color film layer is at least partially overlapped with an orthographic projection of a first light-shielding part on the color film layer, and a width of the first electrode part is greater than a width of the first light-shielding part in the plurality of light-shielding parts in an arrangement direction of the first slit and the second slit; and
acquiring a liquid crystal display panel by forming a liquid crystal layer between the array substrate and the color film substrate.

16. The liquid crystal display device according to claim 14, wherein a ratio of a sum of a width of the first light-shielding part and a width of the first electrode part to twice a target distance is equal to a tangent value of a target angle, wherein
the target angle is determined based on a maximum viewing angle of the liquid crystal display panel;
the target distance is a distance between the first light-shielding part and the first electrode part;
the target angle is an angle between a connection line between projections of a first side edge of the first electrode part and a second side edge of the first light-shielding part in a reference plane and a thickness direction of the liquid crystal display panel, wherein the reference plane is perpendicular to the first side edge and the second side edge; and in an arrangement direction of the first slit and the second slit, the first side edge is a side edge proximal to the first slit, and the second side edge is a side edge proximal to the second slit.

17. The liquid crystal display device according to claim 16, wherein the common electrode layer is made of a metal material.

18. The liquid crystal display device according to claim 14, wherein the array substrate further comprises a base substrate, a drive circuit layer, a planarization layer, a connection electrode layer, a pixel electrode layer, and an insulating layer, wherein the base substrate, the drive circuit layer, the planarization layer, the pixel electrode layer, the insulating layer, and the common electrode layer are sequentially stacked;
the planarization layer comprises a body part provided with a plurality of through holes and a plurality of filling structures in the plurality of through holes, and the pixel electrode layer comprises a plurality of arrayed pixel electrodes;
the connection electrode layer comprises a plurality of connection electrodes, a portion of a first connection electrode in the plurality of connection electrodes is disposed in a first through hole in the plurality of through holes and is electrically connected to the drive circuit layer, and another portion of the first connection electrode is disposed on a side of the planarization layer distal from the base substrate and is connected to a first pixel electrode in the plurality of pixel electrodes, wherein the first pixel electrode covers the first connection electrode and the plurality of filling structures in the first through hole.

19. The liquid crystal display device according to claim 18, wherein orthographic projections of the plurality of filling structures on a carrying face of the base substrate are at least partially not overlapped with an orthographic projection of the black matrix on the carrying face of the base substrate.

20. The liquid crystal display device according to claim 19, wherein
an orthographic projection of the first slit on the carrying face of the base substrate is within an orthographic projection of the first pixel electrode on the carrying face of the base substrate; or
an orthographic projection of the first slit on the carrying face of the base substrate is at least partially overlapped with orthographic projections of a plurality of continuous pixel electrodes arranged in a first direction on the carrying face of the base substrate, wherein the first direction is a length direction of the first slit.
